(19) United States
(12) Patent Application Publication
(10) Pub. No.: US 2006/0153460 A1
(43) Pub. Date: Jul. 13, 2006

(54) Method and apparatus for clustering digital photos based on situation and system and method for albuming using the same

(75) Inventors: Sangkyun Kim, Yongin-si (KR); Jlyeun Kim, Seoul (KR); Youngsu Moon, Seoul (KR); Yongman Ro, Daejeon-si (KR); Seungil Yang, Wonju-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD.

(21) Appl. No.: 11/328,084

(22) Filed: Jan. 10, 2006

(30) Foreign Application Priority Data
Jan. 10, 2005 (KR) 10-2005-0002101
Jan. 5, 2006 (KR) 10-2006-0001286

(51) Int. Cl. G06K 9/62; H04N 5/76

(52) U.S. Cl. 382/225; 348/231.2

(57) ABSTRACT

A method and apparatus for situation-based clustering digital photos, and a digital photo albuming system and method using the same. A situation-based digital photo clustering method of clustering digital photos based on a situation when a photo is taken includes: extracting photographing data information including at least a photographing time feature value from a digital photo file and extracting a content-based feature value from contents of a digital photo of the digital photo file; assigning an importance degree to each extracted photographing time feature value and content-based feature value and combining the values; and hierarchically clustering photographing situations using feature value information, the feature value information being the extracted photographing time feature value and content-based feature value combined with respect to the assigned degrees of importance.

### CROSS-REFERENCE TO RELATED APPLICATIONS

This application claims the benefit of Korean Patent Application No. 10-2005-0002101, filed on Jan. 10, 2005, and No. 10-2006-0001286, filed on Jan. 5, 2006 in the Korean Intellectual Property Office, the disclosures of which are incorporated herein by reference.

### BACKGROUND OF THE INVENTION

1. Field of the Invention

The present invention relates to digital photo clustering, and more particularly, to a method and apparatus for situation-based clustering digital photos, and a digital photo albuming system and method using the same.

2. Description of Related Art

Generally, a digital photo album is used to transfer photos from a digital camera or a memory card to a local storage apparatus and to manage the photos conveniently. Users browse many photos in a time series or in order of event or share the photos with other users by using a photo album.

However, many users are experiencing inconvenience in managing photos by using the conventional photo albums. This is because most of the conventional albums leave the jobs of grouping and labeling photos to users. As the number of photos increases, it becomes more difficult for a user to cluster one by one such that the inconvenience increases. Accordingly, a tool for enabling users to more easily and quickly find desired photos and generate a desired group of a plurality of photos is needed.

In an article entitled “Requirement for Photoware,” (ACM CSCW, 2002), David Frohlich investigated the function of a photo album required by users through a survey of many users. Most interviewees thought storing photos of their lifetime in albums a valuable work. However, they felt the time and effort for grouping many photos one by one inconvenient and experienced difficulties in sharing photos with other people.

In the related research and systems of the initial stage, photos were grouped by using only time information on a time when a photo was taken. As a leading research, there was Adrian Graham's article entitled “Time as essence for photo browsing through personal digital libraries”, (ACM JCDL, 2002). As in this research, by using only the taken time, photos can be grouped roughly. However, this method cannot be used when a photo is taken without storing time information or time information is lost later during photo editing processes. In addition, it is highly probable that an undesired grouping result will be produced if photos taken in similar time bands in different situations by using many cameras are grouped at a time.

In Kerry Rodden's article entitled “How do people manage their digital photographs” (ACM CHI, 2002), a photo album with a function capable of sorting photos using time information was developed and users were interviewed on the utility of the developed system. It shows that even only sorting photos in order of taken time helps users construct albums. However, the article added that in order to more faithfully satisfy the requirements of users, content-based search or event-based photo clustering function should be added.

As described above, as a method to solve problems of photo grouping by using only time information, there is a method using content-based feature values of a photo. So far there have been several researches using time information of photos and content-based feature values together. However, in most cases only color information of a photo is used as a content-based feature value. As a most representative method, Alexander C. Loui's article entitled “automated event clustering and quality screening of consumer pictures for digital albuming” (IEEE Transaction on Multimedia, vol. 5, No. 3, pp. 390-401, 200-3) suggests a method clustering a series of photos based on events by using time and color information of photos. However, since only color histogram information of a photo is used as a content-based feature value, it is very sensitive to brightness changes and it is difficult to sense changes in texture and shapes.

Today, most of digital photo files comply with an exchangeable image file (Exif) format. Exif is a standard file format made by Japan Electronic Industry Development Association (JEIDA). An Exif file stores photographing information such as information on a time when a photo is taken, and camera status information as well as pixel information of a photo.

Also, with the name of MPEG-7, ISO/IEC/JTC1/SC29/WG11 is being used to standardize element technologies required for content-based search in a description structure to express a descriptor and the relations between a descriptor and a description structure. A method for extracting content-based feature values such as color, texture, shape, and motion is suggested as a descriptor. In order to model contents, the description structure defines the relation between two or more descriptor and the description structure and defines how data is expressed.

Accordingly, if various information that can be obtained from a photo file and content-based feature values are used together, more effective photo grouping and searching can be performed. Accordingly, a description structure to express integrally these variety of information items and a photo album providing photo grouping and searching using the structure are needed.

### BRIEF SUMMARY

An aspect of the present invention provides a method and apparatus for situation-based clustering digital photos, by which in order to allow users to easily store photo groups as an album and share grouped photos with other users, photos can be clustered based on photographing situations by using basic photo information stored in a photo file and a variety of content-based feature value information extracted from the contents of photos.

An aspect of the present invention also provides a digital photo album system and method using the method and apparatus for situation-based clustering digital photos.

According to an aspect of the present invention, there is provided a situation-based digital photo clustering method of clustering digital photos based on a situation when a photo is taken. The method includes: extracting photographing data information including at least a photographing time feature value from a digital photo file and extracting a content-based feature value from contents of a digital photo of the digital photo file; assigning an importance degree to each extracted photographing time feature value and content-based feature value and combining the values; and hierarchically clustering photographing situations using feature value information, the feature value information being the extracted photographing time feature value and content-based feature value combined with respect to the assigned degrees of importance.

The content-based feature value may include at least one of the color, texture, and shape of the photo.

The importance degree may be determined according to the semantic feature of the photo.

The importance degree may be assigned differently with respect to the time change distribution feature and content change distribution feature of the input photo data.

In the hierarchical clustering if a photographing time interval is equal to or greater than a predetermined time, it may be detected as a situation change boundary and initial clustering is performed.

The method may further include performing clustering by also using a feature value obtained by combining the photographing time information and the content-based feature value information of a photo, based on the initial situation change boundary detected by the photographing times.

In the hierarchical clustering, when it is assumed that an arbitrary layer is an (r)-th layer, detection of a situation change boundary at the (r)-th layer may be performed based on the situation change boundary determined at the (r-1)-th layer, and this detection process may be repeated until the following expression is satisfied:
thᵣ<thₛₜₒₚ
where thᵣ denotes the similarity degree threshold between photos for detecting a situation change in each layer, and thₛₜₒₚ denotes a stopping criteria of the similarity degree threshold to stop the hierarchical clustering.

In the detection of a situation change boundary at the (r)-th layer, the situation change boundary may be detected by using a time feature value similarity degree and a content-based feature value similarity degree.

The range of objects for similarity degree comparison may be determined according to the following expression:
Bᵣ(i)=[bₘᵢₙ,bₘₐₓ]
where bₘᵢₙ and bₘₐₓ denote two boundaries closest to the i-th photo among the situation change boundaries determined at the (r-1)-th layer, and bₘᵢₙ is determined among photos taken previously to the current i-th photo, and bₘₐₓ is determined among photos taken after the current i-th photo.

The method may further include changing once more the range of objects for similarity degree comparison by finding two photos most similar to the i-th photo of the arbitrary (r) layer according to the following equation:

$${B}_{r}^{′} ( i ) = [ {b}_{min}^{′} , {b}_{max}^{′} ] = [ \begin{matrix}{argmin}_{j} \{ D ( i , j ) \vert {b}_{min} \leq j < i \} , \\ {argmin}_{j} \{ D ( i , j ) \vert i < j \leq {b}_{max} \}\end{matrix} ]$$

where b′ₘᵢₙ denotes the minimum value in the update range of objects for similarity degree comparison, and b′ₘₐₓ denotes the maximum value in the update range of objects for similarity degree comparison.

According to another aspect of the present invention, there is provided a situation-based digital photo clustering apparatus of clustering digital photos based on a situation when a photo is taken. The apparatus includes: a feature value extraction unit extracting photographing data information including at least a photographing time feature value from a digital photo file and extracting a content-based feature value from contents of a digital photo of the digital photo file; an importance degree combination unit assigning an importance degree to each extracted photographing time feature value and content-based feature value and combining the values; and a hierarchical clustering unit hierarchically clustering photographing situations using feature value information, the feature value information being extracted photographing time feature value and content-based feature value combined with respect to the assigned degrees of importance.

According to still another aspect of the present invention, there is provided a situation-based digital photo albuming method. The method includes: receiving a digital photo file; extracting photographing data information including at least a photographing time feature value from the digital photo file and extracting a content-based feature value from the contents of a digital photo of the digital photo file; assigning an importance degree to each extracted photographing time feature value and content-based feature value and combining the values; hierarchically clustering photographing situations using feature value information, the feature value information being the extracted photographing time feature value and the extracted content-based feature value combined with respect to the assigned degrees of importance; and generating the clustered photo string as an album.

According to yet still another aspect of the present invention, there is provided a situation-based digital photo album system including: a photo file input unit receiving a digital photo file; a feature value extraction unit extracting photographing data information including at least a photographing time feature value from a digital photo file and extracting a content-based feature value from the contents of a digital photo of the digital photo file; an importance degree generation unit assigning an importance degree to each extracted photographing time feature value and content-based feature value and combining the values; a hierarchical clustering unit hierarchically clustering photographing situations using feature value information, the feature value information being the extracted photographing time feature value and the extracted content-based feature value combined with respect to the assigned degrees of importance; and an albuming unit generating the clustered photo string as an album.

According to other aspects of the present invention, there are provided computer readable recording media having embodied thereon computer programs for executing the aforementioned methods.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a block diagram of a structure of a digital photo album system using an apparatus for situation-based clustering digital photos according to an embodiment of the present invention;

FIG. 2 is a flowchart of a digital photo albuming method using a method of situation-based clustering digital photos according to an embodiment of the present invention;

FIG. 3 illustrates an example of a result of situation-based clustering photo according to an embodiment of the present invention;

FIG. 4 is a flowchart of a hierarchical clustering procedure according to an embodiment of the present invention;

FIG. 5 illustrates an example of detecting a situation change boundary with respect to layers of hierarchical situation clustering according to an embodiment of the present invention; and

FIG. 6 illustrates an example of comparison of similarity degree distance values for detecting a situation change boundary according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

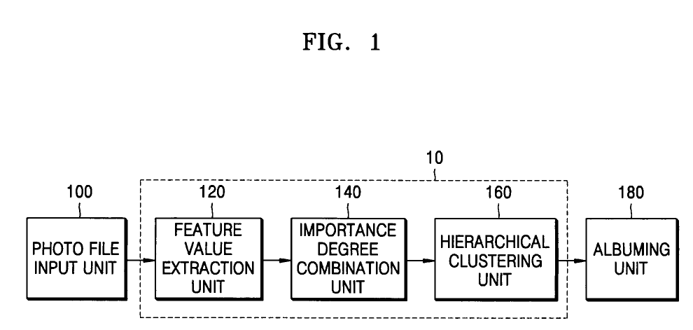

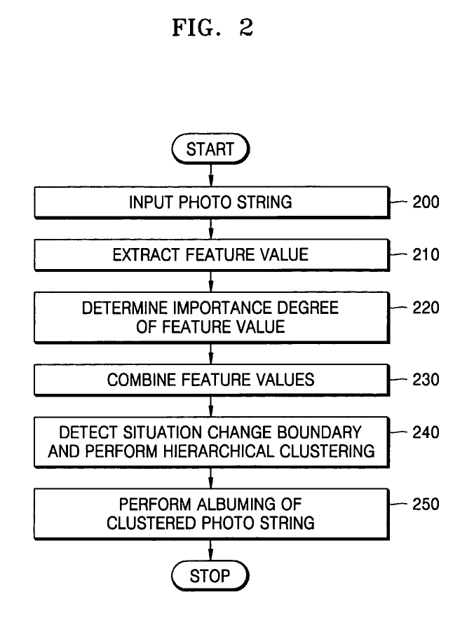

FIG. 1 is a block diagram of a structure of a digital photo album system using an apparatus for situation-based clustering digital photos according to an embodiment of the present invention. FIG. 2 is a flowchart of a digital photo albuming method using a method of situation-based clustering digital photos according to an embodiment of the present invention.

Referring to FIGS. 1 and 2, the digital photo album system and method using the apparatus and method of situation-based clustering digital photos according to an embodiment of the present invention will now be explained.

The situation-based digital photo album system according to an embodiment of the present invention includes a photo file input unit 100, a situation-based photo clustering apparatus 10 and an albuming unit 180. The situation-based digital photo clustering apparatus 10 includes a feature value extraction unit 120, an importance degree combination unit 140 and a hierarchical clustering unit 160.

The photo file input unit 100 receives an input of a digital photo file from a digital photographing apparatus. That is, the photo file input unit 100 receives an input of a photo string from an internal memory device of a digital camera or a portable memory device in operation 200. Photo data is based on ordinary still image data, and the format of the photo data includes any image data format, such as joint photographic experts group (JPEG), tagged image file format (TIFF), and RAW.

The situation-based digital photo clustering apparatus 10 effectively clusters a digital photo album based on situations. The feature value extraction unit 120 extracts photographing data information, including at least a photographing time feature value, from a digital photo file, and extracts a content-based feature value from the contents of a digital photo. From the input photo data, camera information or photographing information stored in the photo file is extracted in operation 210. The camera information stored in the photo file is extracted from Exif data generally used and based on the standard photo file format set by Japan Electronic Industry Development Association (JEIDA). However, the source from which camera information stored in the photo file is extracted is not limited to the Exif data. In the present embodiment, information on the time when a photo is taken can be used as a feature value among the camera information and photographing information. The photographing time feature value can be expressed as the following equation 1:
Fₜᵢₘₑ(i)={F_{year}, fₘₒₙₜₕ, f_{day}, fₕₒᵤᵣ, fₘᵢₙᵤₜₑ, f_{second}} (1).

Here, f_{year}, fₘₒₙₜₕ, f_{day}, fₕₒᵤᵣ, fₘᵢₙᵤₜₑ, and f_{second} respectively denote year, month, day, hour, minute, and second, respectively, of a time when a photo is taken.

Also, by extracting pixel information of the input photo, the content-based feature value of the photo is extracted in operation 210. At this time, if the input photo data is compressed photo data, a decoding process to uncompress the data is performed. As the extracted content-based feature values, there are colors, texture, and shapes of the image. However, the content-based feature values of the photo are not limited to these.

It is assumed that one photo data item is input. At this time, if N different content-based feature values are extracted from an arbitrary i-th photo, the content-based feature values of the i-th photo are expressed as the following equation 2:
i F_{content}(i)={F₁(i),F₂(i), F₃(i), . . . F_{N}(i)} (2).

Here, Fₖ(i) extracted from the i-th photo indicates each feature value vector that is color, texture, or shape feature value.

The importance degree combination unit 140 assigns an importance degree to each of the extracted photographing time feature value and the extracted content-based feature values and combines the values. More specifically, in the present embodiment, an importance degree of each of the extracted variety of feature values is determined in operation 220. This is to achieve a higher clustering performance. This includes a process in which semantic information of concepts of a higher layer is expressed as situation-based clustering hint information, and according to the hint of each photo, the importance degrees of feature values to be used for photo clustering are adaptively set. The importance degree of each feature value can be changed adaptively with respect to the semantic feature of a photo, and a feature value that can extract the semantic value of the photo better is assigned a higher importance degree. The semantic feature of a photo can be extracted automatically from the content-based feature value, but the extracting method is not limited to this. The determined importance degree is combined with the feature values previously extracted and is used to generate a new feature value in operation 230. The importance degree of each content-based feature value is determined according to a given situation-based clustering hint and is expressed as the following equation 3:
V_{content}(i)={v₁(i),v₂(i), v₃(i), . . . , v_{N}(i)} (3).

Here, Vₖ(i) denotes the importance degree of feature value Fₖ(i), and can have a value in a range from 0.0 to 1.0, and according to a give situation-based clustering hint. A new content-based feature value and time feature value reflecting the thus determined importance degree of the feature values are expressed as the following equation 4:
F′_{content}(i)={F_{content}(i), x_{content}(i)}={{F₁(i)},{F₂(i),v₂(i)},{F₃(i),v₃(i)}, . . . ,{F_{N}(i),v_{N}(i)}}, F′ₜᵢₘₑ(i)={Fₜᵢₘₑ(i),Vₜᵢₘₑ(i)}, (4).

Here, F′_{content}(i) denotes the new content-based feature value, and F′ₜᵢₘₑ(i) denotes the new time feature value. These two feature values can be expressed as F′(i)={F′ₜᵢₘₑ(i), F′_{content}(i)}.

The hierarchical clustering unit 160 hierarchically clusters situations in which photos are taken, by using the feature value information items combined with respect to the importance degree. By using the feature value in which the importance degrees are combined, a photo string is clustered based on situations in operation 240. The present embodiment includes a hierarchical clustering method as a method of situation-based clustering photos. That is, a process for hierarchically performing a process to determine a situation change boundary of each photo is included. The hierarchical situation clustering has an advantage that it is useful for a user to adjust the number of desired clusters. In a lower layer, the clustering of input photos is coarse and the number of situation clusters is small. Reversely, in a higher layer, the clustering of input photos is fine and the number of situation clusters is large.

In the present embodiment, a situation is defined as a situation of a place having no great difference in terms of distance. Even photos belonging to an identical situation may have different brightness, saturations, colors, resolutions with respect to surrounding environments such as a camera setting, weather, and external illumination. Even photos belonging to an identical situation may have different backgrounds with respect to the direction of the camera taking the photos.

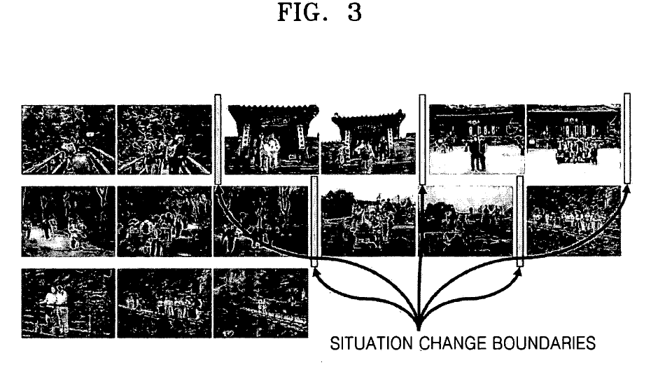

FIG. 3 illustrates an example of a result of situation-based clustering photo according to an embodiment of the present invention. Referring to FIG. 3, 15 photos with not large intervals between taken times are arranged in order of photographing time. Division lines indicate boundaries in which situations change.

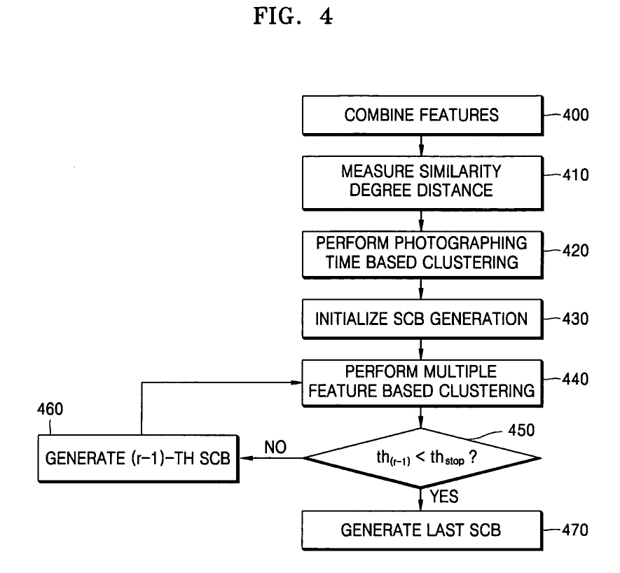

FIG. 4 is a flowchart of a hierarchical clustering procedure according to an embodiment of the present invention. First, photos are arranged in order of the taken times and feature values are combined in operation 400. In the initial stage, the combination of the feature values uses only time feature values. Next, by using the combined feature value, the similarity degree between neighboring photos is measured in operation 410. The similarity degree of a current photo (i) and an arbitrary neighboring photo (j) is broken down to a similarity degree using only time feature values and a similarity degree using content-based feature values. The similarity degree using only time feature values is expressed as the following equation 5:
Dₜᵢₘₑ(i,j)=Φ{F′ₜᵢₘₑ(i)−F′ₜᵢₘₑ(j)}. (5).

Here, Φ is a function for scaling a time difference to be more sensitive to a smaller time interval, and for this, a log function and the like can be used. When time information is used without change, if an interval between two photos is small, the change in the difference value is insignificant and with the increasing time interval, the change in the difference value increases rapidly. Accordingly, scaling is needed.

The similarity degree distance value using the content-based feature values is expressed as the following equation 6:
D_{content}(i,j)=F′_{content}(i)−F′_{content}(j)={D₁(i,j),D₂(i,j),D₃(i,j), . . . ,D_{N}(i,j)}. (6)

Next, in each of the input photos, a situation change boundary is detected by using the time feature value similarity degree and the content-based feature value similarity degree measured according to the method described above.

First, by using only the time feature value similarity degree of a photo, a situation change boundary of the photo is detected in operation 420. Generally, photos belonging to an arbitrary situation have relatively smaller time differences. Accordingly, the time feature value plays the most important role in determining a situation change. By using this characteristic, the present embodiment first clusters photos coarsely such that an initial cluster is determined in operation 430. With the initial cluster, hierarchical situation clustering is performed by using both the time feature value similarity degree and the content-based feature value similarity degree of the photo.

Whether or not a situation changes in an i-th photo is determined according to the time feature value similarity degree of a photo and detection of a situation change boundary of a photo is expressed as the following equation 7:

$$S ( i ) = \{ \begin{matrix}true , & {D}_{time} ( i , i - 1 ) > {th}_{init} \\ false , & otherwise\end{matrix} . \qquad ( 7 )$$

Whether or not the i-th photo is a situation change boundary is determined by comparing the time feature value similarity degree of the i-th photo with an arbitrary initial threshold (thᵢₙᵢₜ). That is, if the time feature value similarity degree of the i-th photo is greater than the initial threshold (thᵢₙᵢₜ), it is determined that a situation change occurs in the i-th photo (S(i)=true). Reversely, if the time feature value similarity degree of the i-th photo is less than the initial threshold (thᵢₙᵢₜ), it is determined that a situation change does not occur in the i-th photo (S(i)=false).

According to the determined situation change boundary Sr(i), a set of initial situation change boundaries is determined. The initial situation boundary is expressed as the following equation 8:
sᵣ₌₁={s(0).S(1),S(2), . . . ,S(I)} (8).

Here, (r) indicates a stage of layers (r ε{1,2,3, . . . ,R}) Since it is the initial set of situation change boundaries detected with only the time feature value similarity degrees,, (r) at the present time is 1. Here, the top layer is expressed as R.

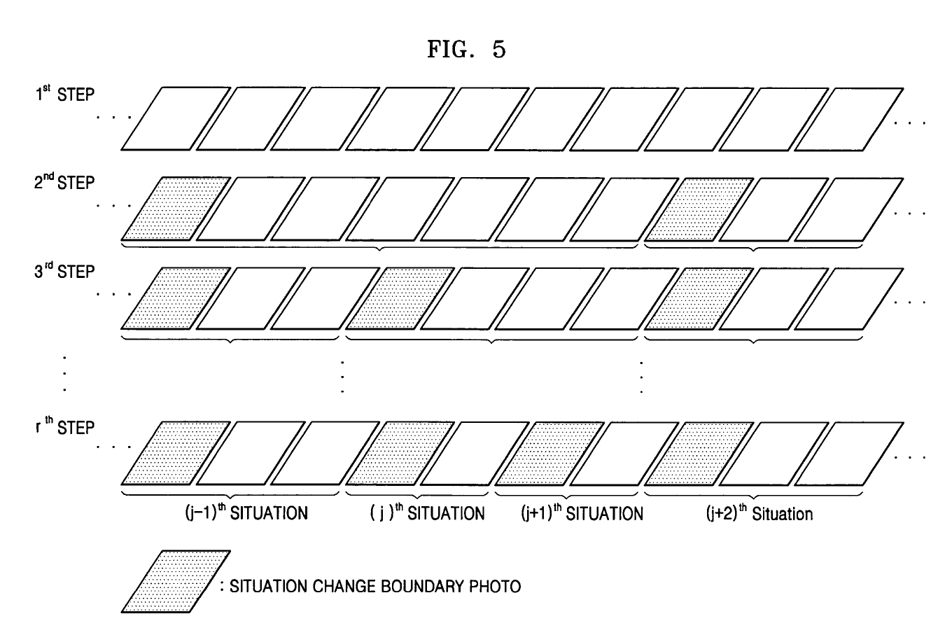

FIG. 5 illustrates an example hierarchical situation clustering according to an embodiment of the present embodiment. If the layer (r) is 1, that is, if the layer is the first one, a situation change boundary is determined according to the method described above with taking precedence over time information. If the layer (r) is greater than 1, that is, from the second layer, a situation change boundary is determined by using not only the time feature value similarity degree but also the content-based feature value similarity degree of a photo. Detection of a situation change boundary in the second layer is performed on the basis of the situation change boundary determined in the first layer. Detection of a situation change boundary in the third layer is performed on the basis of the situation change boundary determined in the second layer. This process is repeatedly performed to the top layer, R.

The present embodiment includes a process for reducing the threshold of a similarity degree to detect a situation change boundary with the increasing layer, that is, with the increasing (r) value. The reduction of the threshold is expressed as the following equation 9:
thᵣ=thᵢₙᵢₜ−Δthᵣ (9).

Here, thᵣ denotes the threshold at a layer (r) and varies on the basis of the initial threshold thᵢₙᵢₜ. Δthᵣ denotes the change amount of the threshold at the r-th layer.

Next, a process for detecting a situation change boundary in the determined initial situation change boundary set is performed in operation 440. At this time, in addition to the time feature value similarity degree of a photo, the content-based feature value similarity degree is used together.

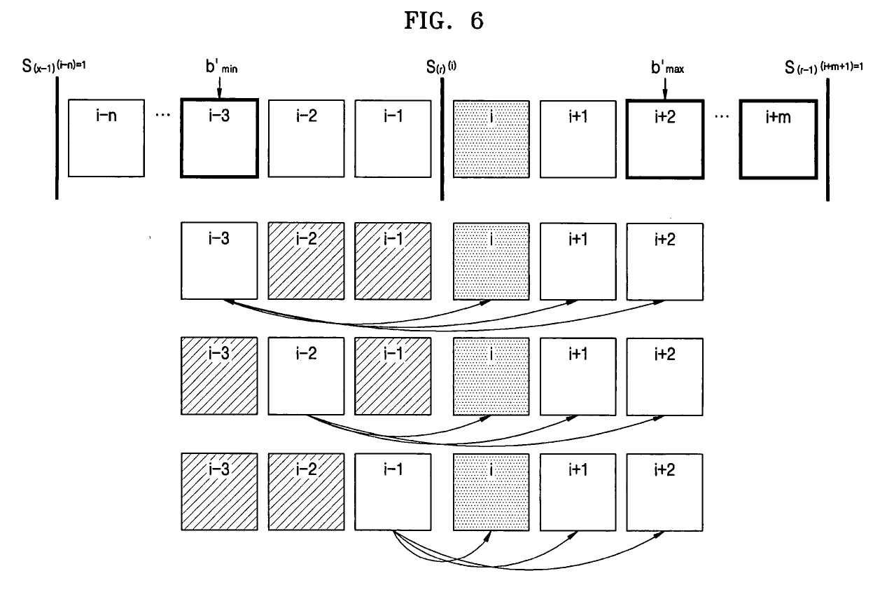

FIG. 6 illustrates an example of a method of detecting a situation change boundary at the r-th layer. In the example, whether or not a situation change occurs in a current i-th photo is determined from S(r-1) that is a set of situation change boundaries determined at the (r-1)-th layer. It is assumed that among the situation change boundary sets determined to the (r-1)-th layer, the (i−n)-th photo and the (i+m+1)-th photos are detected as situation change boundaries. At this time, the range of objects for similarity degree comparison is determined from the (i−n)-th photo to the (i+m)-th photo. At the r-th layer, the range of objects for similarity degree comparison is expressed as the following equation 10:
Bᵣ(i)=[bₘᵢₙ,bₘₐₓ] (10).

Here, bₘᵢₙ and bₘₐₓ denote two boundaries closest to the i-th photo among the situation change boundaries determined at the (r-1)-th layer. However, bₘᵢₙ is determined among photos taken previously to the current i-th photo, and bₘₐₓ is determined among photos taken after the current i-th photo. In the example of FIG. 6, bₘᵢₙ is (i−n) and bₘₐₓ is (i+m). The range of objects for similarity degree comparison (Br(i)) is changed once again by finding two photos most similar to the i-th photo. This is to avoid comparison with many photos that are not actually similar when there are many photos in the range. That is, by reducing the range of objects for similarity degree comparison, the range is updated.

The updated range of objects for similarity degree comparison is expressed as the following equation 11:

$${B}_{r}^{′} ( i ) = [ {b}_{min}^{′} , {b}_{max}^{′} ] = [ \begin{matrix}{argmin}_{j} \{ D ( i , j ) \vert {b}_{min} \leq j < i \} , \\ {argmin}_{j} \{ D ( i , j ) \vert i < j \leq {b}_{max} \}\end{matrix} ] . \qquad ( 11 )$$

Here, b′ₘᵢₙ denotes the minimum value in the update range of objects for similarity degree comparison, and b′ₘₐₓ denotes the maximum value in the update range of objects for similarity degree comparison.

In order to obtain a similarity degree value to detect whether or not a situation change occurs in the i-th photo, in the given range of objects for similarity degree comparison, photos taken after the (b′ₘᵢₙ)-th photo among the photos taken before the current photo are compared with photos taken before the (b′ₘₐₓ)-th photo among the photos taken after the current photo. The similarity degree value to detect whether or not a situation change occurs in the i-th photo is expressed as the following equation 12:

$$\begin{matrix}{Z}_{r} ( i ) = {D}_{{f}^{′}}^{′} ( i , {b}_{min}^{′} ) - {D}_{{f}^{′}}^{′} ( i , {b}_{max}^{′} ) + \\ \frac{{\sum }_{j = {b}_{min}^{′}}^{i - 1} [ {\sum }_{k = i}^{{b}_{max}^{′}} \{ {\sum }_{{f}^{′} ∈ {F}^{′}} {D}_{{f}^{′}}^{′} ( j , k ) \} ]}{M} ,\end{matrix} \\ where {D}_{{f}^{′}}^{′} ( {j}_{1} , {j}_{2} ) {\vert}_{i} = \frac{{v}_{{f}^{′}} ( i ) \times {D}_{{f}^{′}} ( {j}_{1} , {j}_{2} )}{{\sum }_{{f}^{′} ∈ {F}^{′}} {v}_{{f}^{′}} ( i )} . \qquad ( 12 )$$

Here, ^{v}f′ represents importance degree of each feature of photo. And M denotes the number of photos in an interval [b′ₘᵢₙ, b′ₘₐₓ] and has a value (b′ₘₐₓ−b′ₘᵢₙ,+1) If the i-th photo is a situation change boundary, the similarity degree distance value D′_{f}(i,b′ₘᵢₙ) with the photo taken before the i-th photo is a relatively large value, the similarity degree distance value D′_{f}(i,b′ₘₐₓ) with the photo taken after the i-th photo is a relatively small value.

The similarity degree distance value

$$\frac{{\sum }_{j = {b}_{min}^{′}}^{i - 1} [ {\sum }_{k = i}^{{b}_{max}^{′}} \{ {\sum }_{{f}^{′} ∈ {F}^{′}} {D}_{{f}^{′}}^{′} ( j , k ) \} ]}{M}$$

between the photos taken before the i-th photo and the photos taken after the i-th photo is a relatively large value. Accordingly, if the i-th photo is a situation change boundary, the i-th photo has a relatively larger value Zᵣ(i) than that in a photo that is not a situation change boundary.

Among the three terms used in the equation 12, only D′_{f}(i,b′ₘᵢₙ)−D′_{f}(i,b′ₘₐₓ) is used, or

$$\frac{{\sum }_{j = {b}_{min}^{′}}^{i - 1} [ {\sum }_{k = i}^{{b}_{max}^{′}} \{ {\sum }_{{f}^{′} ∈ {F}^{′}} {D}_{{f}^{′}}^{′} ( j , k ) \} ]}{M}$$

is used. However, the present embodiment is not limited to these.

If the similarity degree measured according to the equation 12 exceeds an arbitrary threshold, it is determined that a situation change occurs in the i-th photo. Whether or not a situation change occurs in the i-th photo at layer (r) is expressed as the following equation 13:

$$S ( i ) = \{ \begin{matrix}true , & {Z}_{r} ( i ) > th , \\ false , & otherwise\end{matrix} . \qquad ( 13 )$$

It is determined whether or not the condition of the following equation 14 is satisfied in the process for detecting of a situation change in operation 450. Until the condition is satisfied, the process is repeatedly performed by increasing the layer in operation 460. If the similarity degree measured by the equation 12 is less than an arbitrary threshold, the threshold is reduced according to the equation 9 and the layer is increased such that clustering is performed more finely.
thᵣ<thₛₜₒₚ (14).

Here, thₛₜₒₚ denotes a stopping criteria to stop the hierarchical clustering. By doing so, a final situation change boundary is generated in operation 470.

Finally, the albuming unit 180 generates the clustered photo string into an album. A process for indexing the finally determined situation clusters at a time is performed. The indexing may be performed by a user or may be performed automatically by the system. Also, this can be utilized as a preparatory operation for event-based clustering and indexing. By doing so, the clustered photo string is generated as an album in operation 250.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices.

According to the above-described embodiments of the present invention, in addition to information items that can be basically obtained from a photo such as camera information and file information stored in the photo, by using content-based feature value information that can be obtained from the content of a photo such as color, texture, and shape, situation-based photo clustering is performed. By doing so, a large amount of photo data can be used to quickly and effectively generate an album.

Furthermore, by using the hierarchical clustering method, the degree of clustering can be freely selected with respect to the feature of input photo data or user's request.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A situation-based digital photo clustering method of clustering digital photos based on a situation when a photo is taken, the method comprising:
extracting photographing data information including at least a photographing time feature value from a digital photo file and extracting a content-based feature value from contents of a digital photo of the digital photo file;
assigning an importance degree to each extracted photographing time feature value and content-based feature value and combining the values; and
hierarchically clustering photographing situations using feature value information, the feature value information being the extracted photographing time feature value and content-based feature value combined with respect to the assigned degrees of importance.

2. The method of claim 1, wherein the content-based feature value includes at least one of a color, texture, and shape of the digital photo.

3. The method of claim 1, wherein the importance degree is determined according to a semantic feature of the digital photo.

4. The method of claim 1, wherein the importance degree is assigned differently with respect to a time change distribution feature and a content change distribution feature of the input digital photo file.

5. The method of claim 1, wherein, in the hierarchical clustering, when a photographing time interval is at least equal to a predetermined time, the photographic time interval is detected as a situation change boundary and initial clustering is performed.

6. The method of claim 5, further comprising performing clustering using a feature value obtained by combining the photographing time information and the content-based feature value information, based on an initial situation change boundary detected by photographing times.

7. The method of claim 1, wherein, in the hierarchical clustering, when it is assumed that an arbitrary layer is an (r)-th layer, detection of a situation change boundary at an (r)-th layer is performed based on the situation change boundary determined at the (r-1 )-th layer, and this detection process is repeated until the following expression is satisfied:
thᵣ<thₛₜₒₚ
, and
wherein thᵣ denotes the similarity degree threshold between photos for detecting a situation change in each layer, and thₛₜₒₚ denotes a stopping criteria of a similarity degree threshold to stop the hierarchical clustering.

8. The method of claim 7, wherein, in the detection of a situation change boundary at the (r)-th layer, the situation change boundary is detected using a time feature value similarity degree and a content-based feature value similarity degree.

9. The method of claim 8, wherein the range of objects for similarity degree comparison is determined according to the following expression:
Bᵣ(i)=[bₘᵢₙ,bₘₐₓ]
, and
wherein bₘᵢₙ and bₘₐₓ denote two boundaries closest to an i-th photo among the situation change boundaries determined at the (r-1)-th layer, and bₘᵢₙ is determined among photos taken previously to a current i-th photo, and bₘₐₓ is determined among photos taken after the current i-th photo.

10. The method of claim 9, further comprising changing the range of objects for similarity degree comparison by finding two photos most similar to the i-th photo of the arbitrary (r) layer according to the following equation:
$${B}_{r}^{′} ( i ) = [ {b}_{min}^{′} , {b}_{max}^{′} ] = [ \begin{matrix}{argmin}_{j} \{ D ( i , j ) \vert {b}_{min} \leq j < i \} , \\ {argmin}_{j} \{ D ( i , j ) \vert i < j \leq {b}_{max} \}\end{matrix} ] , and$$
wherein b′ₘᵢₙ denotes the minimum value in an update range of objects for similarity degree comparison, and b′ₘₐₓ denotes the maximum value in the update range of objects for similarity degree comparison.

11. The method of claim 8, wherein the time feature value similarity degree and the content-based feature value similarity degree are determined by calculating a similarity degree distance value of a current photo with respect to an adjacent photo using the following equation:
$${Z}_{r} ( i ) = \frac{{\sum }_{j = {b}_{min}^{′}}^{i - 1} [ {\sum }_{k = i}^{{b}_{max}^{′}} \{ {\sum }_{{f}^{′} ∈ {F}^{′}} {D}_{{f}^{′}}^{′} ( j , k ) \} ]}{M} , \\ where$$
$${D}_{{f}^{′}}^{′} ( {j}_{1} , {j}_{2} ) {\vert}_{i} = \frac{{v}_{f} ( i ) \times {D}_{{f}^{′}} ( {j}_{1} , {j}_{2} )}{{\sum }_{{f}^{′} ∈ {F}^{′}} {v}_{{f}^{′}} ( i )} , and$$
wherein M denotes the number of photos in an interval [b′ₘᵢₙ, b′ₘₐₓ] and has a value (b′ₘₐₓ−b′ₘᵢₙ,+1).

12. The method of claim 8, wherein the time feature value similarity degree and the content-based feature value similarity degree are determined by calculating a similarity degree distance value of a current photo with respect to an adjacent photo using the following equation:
$${Z}_{r} ( i ) = {D}_{{f}^{′}}^{′} ( i , {b}_{min}^{′} ) - {D}_{{f}^{′}}^{′} ( i , {b}_{max}^{′} ) , \\ where$$
$${D}_{{f}^{′}}^{′} ( {j}_{1} , {j}_{2} ) {\vert}_{i} = \frac{{v}_{f} ( i ) \times {D}_{{f}^{′}} ( {j}_{1} , {j}_{2} )}{{\sum }_{{f}^{′} ∈ {F}^{′}} {v}_{{f}^{′}} ( i )} .$$

13. The method of claim 11, wherein it is determined using the following equation that a situation change occurs in an i-th photo when the determined similarity degree value is greater than an arbitrary threshold:
$$S ( i ) = \{ \begin{matrix}true , & {Z}_{r} ( i ) > {th}_{r} \\ false , & otherwise ,\end{matrix} and$$
wherein thᵣ is a threshold value at layer (r).

14. The method of claim 12, wherein it is determined using an equation below that a situation change occurs in an i-th photo when the determined similarity degree value is greater than an arbitrary threshold:
$$S ( i ) = \{ \begin{matrix}true , & {Z}_{r} ( i ) > {th}_{r} \\ false , & otherwise ,\end{matrix} and$$
wherein thᵣ is a threshold value at layer (r).

15. A situation-based digital photo clustering apparatus of clustering digital photos based on a situation when a photo is taken, the apparatus comprising:
a feature value extraction unit extracting photographing data information including at least a photographing time feature value from a digital photo file and extracting a content-based feature value from contents of a digital photo of the digital photo file;
an importance degree combination unit assigning an importance degree to each extracted photographing time feature value and content-based feature value and combining the values; and
a hierarchical clustering unit hierarchically clustering photographing situations using feature value information, the feature value information being extracted photographing time feature value and content-based feature value combined with respect to the assigned degrees of importance.

16. The apparatus of claim 15, wherein the content-based feature value of the feature value extraction unit includes at least one of a color, texture, and shape of the digital photo.

17. The apparatus of claim 15, wherein the importance degree of the importance degree combination unit is determined according to a semantic feature of the digital photo.

18. The apparatus of claim 15, wherein the importance degree of the importance degree combination unit is assigned differently with respect to a time change distribution feature and a content change distribution feature of the input digital photo file.

19. The apparatus of claim 15, wherein, in the hierarchical clustering of the hierarchical clustering unit, when a photographing time interval is at least equal to a predetermined time, the photographing time interval is detected as a situation change boundary and initial clustering is performed.

20. The apparatus of claim 19, wherein the hierarchical clustering of the hierarchical clustering unit also includes clustering using a feature value obtained by combining the photographing time information and the content-based feature value information of a photo, based on the initial situation change boundary detected by the photographing times.

21. The apparatus of claim 15, wherein, in the hierarchical clustering by the hierarchical clustering unit, when it is assumed that an arbitrary layer is an (r)-th layer, detection of a situation change boundary at the (r)-th layer is performed based on the situation change boundary determined at the (r-1)-th layer, and this detection process is repeated until the following expression is satisfied:
thᵣ<thₛₜₒₚ
, and
wherein thᵣ denotes a similarity degree threshold between photos for detecting a situation change in each layer, and thₛₜₒₚ denotes a stopping criteria of the similarity degree threshold to stop the hierarchical clustering.

22. The apparatus of claim 21, wherein, in the detection of a situation change boundary at the (r)-th layer, the situation change boundary is detected by using a time feature value similarity degree and a content-based feature value similarity degree.

23. The apparatus of claim 22, wherein the range of objects for similarity degree comparison is determined according to the following expression:
Bᵣ(i)=[bₘᵢₙ,bₘₐₓ]
, and
wherein bₘᵢₙ and bₘₐₓ denote two boundaries closest to an i-th photo among the situation change boundaries determined at the (r-1)-th layer, and bₘᵢₙ is determined among photos taken previously to a current i-th photo, and bₘₐₓ is determined among photos taken after the current i-th photo.

24. A situation-based digital photo albuming method comprising:
receiving a digital photo file;
extracting photographing data information including at least a photographing time feature value from the digital photo file and extracting a content-based feature value from the contents of a digital photo of the digital photo file;
assigning an importance degree to each extracted photographing time feature value and content-based feature value and combining the values;
hierarchically clustering photographing situations using feature value information, the feature value information being the extracted photographing time feature value and the extracted content-based feature value combined with respect to the assigned degrees of importance; and
generating the clustered photo string as an album.

25. A situation-based digital photo album system comprising:
a photo file input unit receiving a digital photo file;
a feature value extraction unit extracting photographing data information including at least a photographing time feature value from a digital photo file and extracting a content-based feature value from the contents of a digital photo of the digital photo file;
an importance degree generation unit assigning an importance degree to each extracted photographing time feature value and content-based feature value and combining the values;
a hierarchical clustering unit hierarchically clustering photographing situations using feature value information, the feature value information being the extracted photographing time feature value and the extracted content-based feature value combined with respect to the assigned degrees of importance; and
an albuming unit generating the clustered photo string as an album.

26. A computer readable recording medium having embodied thereon a computer program for executing the method of claim 1.

27. A computer readable recording medium having embodied thereon a computer program for executing the method of claim 24.
